(19) United States
(12) Patent Application Publication
(10) Pub. No.: US 2008/0180377 A1
(43) Pub. Date: Jul. 31, 2008

(54) Liquid crystal display device

(75) Inventor: Kai Meng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/005,929

(22) Filed: Dec. 29, 2007

(30) Foreign Application Priority Data
Dec. 29, 2006 (TW) 95149707

(51) Int. Cl. G09G 3/36

(52) U.S. Cl. 345/94

(57) ABSTRACT

An LCD device (200) includes a first substrate (312), a second substrate (322) facing the first substrate, a liquid crystal layer (330) sandwiched between the first substrate and the second substrate, a common electrode (314), a lot of pixel electrode (3231) and a control electrode (316). The pixel electrodes are arranged on the second substrate and a gray voltage is provided to the pixel electrodes. The common electrode is provided between the first substrate and the liquid crystal layer. The control electrode defining windows (3162) is provided between the common electrode and the liquid crystal layer and is electrically insulated with the common electrode. A control voltage signal is able to be provided to the control electrode selectively and if the control voltage signal is provided to the control electrode, twist direction of liquid crystal molecules corresponding to the control electrode is different from the twist direction of the liquid crystal molecules corresponding to the windows.

### FIELD OF THE INVENTION

The present invention relates to liquid crystal display (LCD) devices, and particularly to an LCD device that can shift a viewing angle.

### GENERAL BACKGROUND

Because LCD devices have the advantages of portability, low power consumption, and low radiation, they have been widely used in various portable information products such as notebooks, personal digital assistants (PDAs), video cameras, and the like. Commonly, the LCD device has been developed towards two different aspects according to requirements of users. One aspect is tending to a narrow viewing angle mode LCD device having a function of protecting displaying information from being leaking out to others. The other one is tending to a wide viewing angle mode LCD device that is popularly required in public, such as in optical compensation twist nematic (TN) mode LCDs, plane switching (IPS) mode LCDs, multi-domain vertical alignment (MVA) mode and patterned vertical alignment (PVA) mode LCDs.

In MVA mode LCD devices, each pixel unit is divided into multiple domains. Liquid crystal molecules of the pixel unit are vertically aligned when no voltage in applied, and are inclined in different directions according the domains where they are when a voltage is applied. In other words, in each pixel unit, an effective direction of an electric field in a domain is different from the effective direction of the electric field in a neighboring domain. Typical MVA mode LCD devices have four domains in each pixel unit thereof. Generally, protrusions and/or slits are formed to define the domains.

Referring to FIG. 4, part of a typical MVA mode LCD device 100 is shown. The MVA LCD device 100 includes liquid crystal molecules 160 oriented in four domains A, B, C, D. Protrusions 111, 121 are arranged on inner surfaces of two substrates (not shown) respectively, along generally V-shaped paths. The liquid crystal molecules 160 at two opposite sides of upper portions of the protrusions 111, 121 are inclined in the directions C and D, while liquid crystal molecules 160 at two opposite sides of lower portions of the protrusions 111, 121 are inclined in the directions A and B. The orientation direction of the liquid crystal molecules 160 in each same inter-protrusion region (e.g., the direction A in a region A) is orthogonal to the orientation directions of the liquid crystal molecules 160 in the other inter-protrusion regions (e.g., the directions B, C, D in regions B, C, D). Therefore, each pixel unit attains a visual effect that is an overall result of four domains. This gives the MVA LCD device 100 a more even display performance at various different viewing angles.

Because an LCD device, especially a wide viewing angle mode LCD device, such as the MVA LCD device 100 can not shift the current viewing angle to a narrow viewing angle by itself, a micro-louver film (not shown) configured to concentrate light beams is provided. The micro-louver film is commonly attached to a displaying surface of the LCD device in order that users can see the displaying information in a limited viewing angle range. The limited viewing angle is generally 60 degrees. However, a process of attaching or stripping off the micro-louver film is inconvenient. Furthermore, if the micro-louver film is attached irregularly, a visible defect in the form of Mura occurs.

What is needed, therefore, is an LCD device that can overcome the above-described deficiencies.

### SUMMARY

In one preferred embodiment, an LCD device includes a first substrate, a second substrate facing to the first substrate, a liquid crystal layer sandwiched between the first substrate and the second substrate, a common electrode, a plurality of pixel units arranged in a matrix and a control electrode. Each pixel unit includes a pixel electrode that is applied with a gray voltage. The common electrode is provided between the first substrate and the liquid crystal layer. The control electrode having a plurality of windows is provided between the common electrode and the liquid crystal layer and is electrically insulated with the common electrode. A control voltage signal is able to be provided to the control electrode selectively and if the control voltage signal is provided to the control electrode, twist direction of liquid crystal molecules corresponding to the control electrode is different from the twist direction of the liquid crystal molecules corresponding to the windows.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side, plan view of an LCD device according to an exemplary embodiment of the present invention, the LCD device including a control electrode.

FIG. 2 is an enlarged, top plan view of part of the control electrode of FIG. 1.

FIG. 3 is an abbreviated waveform diagram of gray voltages of the LCD device of FIG. 1 and a control voltage signal applied to the control electrode of FIG. 1.

FIG. 4 is a schematic, top elevation of part of a conventional MVA LCD device in an on state, not showing a first substrate or a main body of a common electrode of the LCD device, but showing orientations of liquid crystal molecules of the LCD device.

### DETAILED DESCRIPTION OF PREFERRED EMBODIMENTS

Referring to FIG. 1, an LCD device 200 according to an exemplary embodiment of the present invention is shown. The LCD device 200 includes a liquid crystal panel 30 and a backlight module 40. The backlight module 40 is configured to provide uniform light beams to the liquid crystal panel 30. The liquid crystal panel 30 includes a first substrate assembly 310, a second substrate assembly 320 arranged in a position facing the first substrate assembly 310, and a liquid crystal layer 330 interposed between the first substrate assembly 310 and the second substrate assembly 320.

The first substrate assembly 310 includes a first polarizer 311, a first substrate 312, a color filter 313, a common electrode 314, an insulating layer 315, a control electrode 316 and a first alignment layer 317, disposed in that order from top to bottom. The second substrate assembly 320 includes a second polarizer 321, a second substrate 322, a pixel array 323 and a second alignment layer 324, disposed in that order from bottom to top. The pixel array 323 defines a plurality of pixel units arranged in a matrix. Each pixel unit includes a pixel electrode 3231 and a thin film transistor (not shown) that function as switching elements. The thin film transistor is connected to the pixel electrode 3231 of the corresponding pixel unit. The first and second substrate 312, 322 are made from a transparent material, such as glass or quartz. Original rubbing directions of the alignment layers 317, 324 are perpendicular to each other. Polarizing axis of the first polarizer 311 is perpendicular to that of the second polarizer 321. The liquid crystal panel 30 can be a wide view-angle mode display panel, such as an MVA display panel.

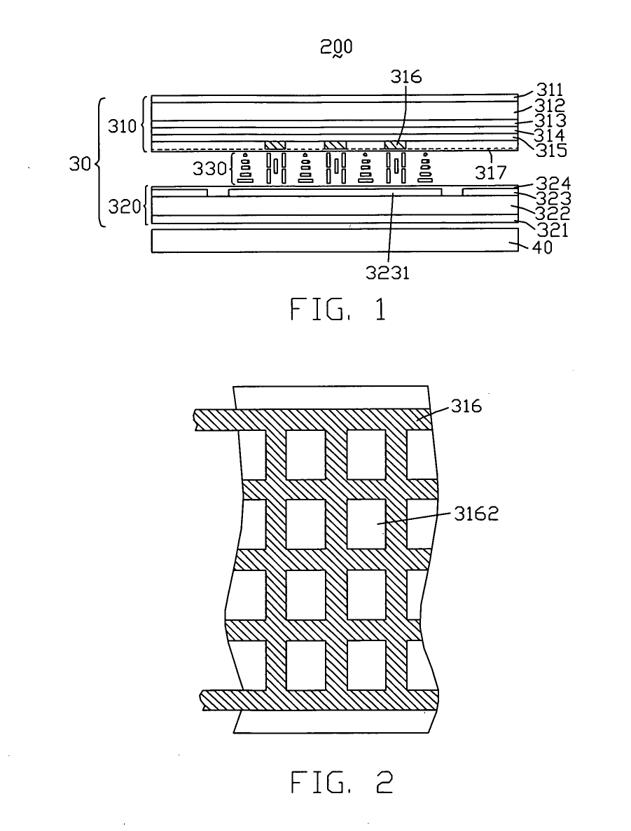

Referring also to FIG. 2, part of the control electrode 316 is shown. The control electrode 316 is made from a transparent conductive material, such as indium-zinc-oxide (IZO) or indium-tin-oxide (ITO). The control electrode 316 has a grid shape, thus defines a plurality of rectangular windows 3162 and the rectangular windows 3162 are arranged in a matrix. Each pixel unit corresponds to at least one rectangular window 3162. A total area of the rectangular windows 3162 in each pixel unit is 5%˜95% of the area of the corresponding pixel electrode 3231.

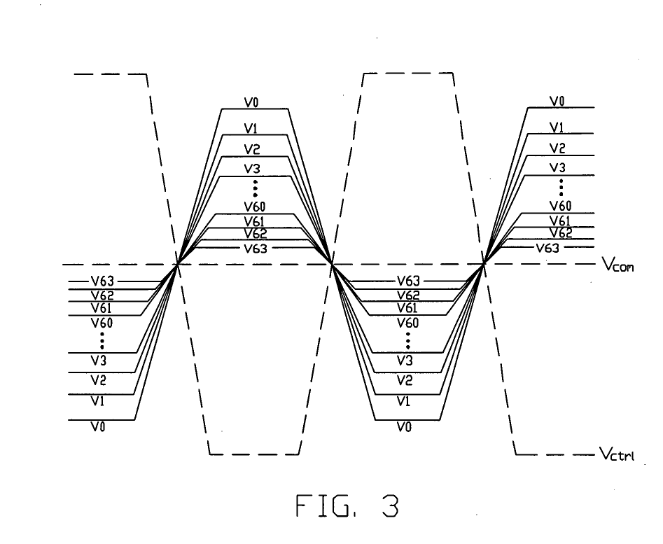

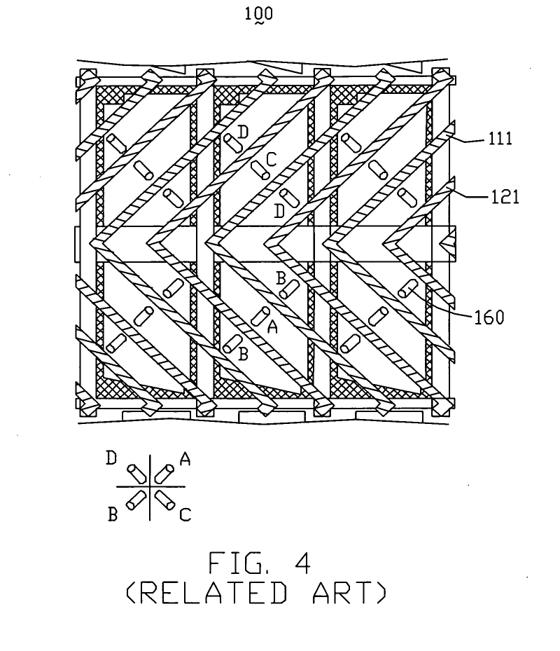

Referring to FIG. 3, this is an abbreviated waveform diagram of gray voltages of the LCD device 200 and a control voltage signal applied to the control electrode 316. Vcom represents a common voltage signal applied to the common electrode 314. V0˜V63 show waveforms of the gray voltages applied to the pixel electrodes 3231. Vctrl represents the control voltage signal applied to the control electrode 316. A voltage phase of the control voltage signal Vctrl is inverse to voltage phases of the gray voltages V0˜V63. A voltage difference between the control voltage signal Vctrl and one of the gray voltages V0˜V63 (for example, a current gray voltage V60) is not less than a saturation voltage value of the liquid crystal molecules. An exemplary displaying method of the LCD device 200 is as follows:

When no voltage signal is provided to the LCD device 200, the LCD device 200 is in a black state. When no control voltage signal Vctrl is provided to the control electrode 316, and at the same time, the current gray voltage V60 and the common voltage signal Vcom are provided to the pixel electrodes 3231 and the common electrode 314 respectively, a first electric field is generated between the pixel electrode 3231 and the common electrode 314 and the LCD device 200 is not only in a white state but also has a wide viewing angle.

When the common voltage signal Vcom, the current gray voltage V60 and the control voltage signal Vctrl are provided to the common electrode 314, the pixel electrodes 3231 and the control electrode 316 respectively, a second electric field is generated between the pixel electrodes 3231 and the control electrode 316. Thus liquid crystal molecules of the liquid crystal layer 330 corresponding to the rectangular windows 3162 and the control electrode 316 respectively twist in these two electric fields. On the one hand, long axes of the liquid crystal molecules corresponding to the rectangular windows 3162 twist by the first electric field. On the other hand, because the voltage difference between the control voltage signal Vctrl and the current gray voltage V60 is equal to or larger than the saturation voltage value of the liquid crystal molecules, an electric field intensity of the second field is high enough and long axes of liquid crystal molecules corresponding to the control electrode 316 twist to a direction perpendicular to the two substrate assembly 310, 320 by the second electric field thereby losing their optical rotation characteristics.

When light emitted from the backlight module 40 enters the liquid crystal panel 30, the light becomes linearly-polarized light having a polarizing direction parallel to the polarizing axis of the second polarizer 321 after passing through the second polarizer 321 and is reaching the liquid crystal layer 330. Directions of part of light emitted from the backlight module 40 are perpendicular to the two substrates assembly 310, 320, and directions of other part of light emitted from the backlight module 40 are inclined. In the white state, most of linearly-polarized light perpendicular to the two substrates assembly 310, 320 passes through the liquid crystal molecules corresponding to the rectangular windows 3162. The polarizing direction of these linearly-polarized light is converted to match the polarizing axis of the first polarizer 311. On the other hand, most of linearly-polarized inclined light passes through the liquid crystal molecules corresponding to the control electrode 316 which long axes of the liquid crystal molecules are perpendicular to the two substrates assembly 310, 320. These linearly-polarized inclined light maintains the polarizing direction perpendicular to the polarizing axis of the first polarizer 311 thereby being absorbed by the first polarizer 311. This means that pluralities of optical channels are formed by the liquid crystal molecules corresponding to the windows 3162. Thus only the light having incident directions approximately parallel to the optical channels can pass through the liquid crystal panel 30. Therefore, the LCD device 200 has a narrow viewing angle when the control voltage signal Vctrl is provided to the control electrode 316.

In summary, the LCD device 200 can shift the viewing angle by applying the control voltage signal Vctrl to the control electrode 316 or not. This operation method is more convenient. At the same time, the LCD device 200 can avoid visible defects resulted by attaching a micro-louver film. In addition, the total area of the rectangular windows 3162 determines the viewing angle range of the LCD device 200. If the total area of the rectangular windows 3162 is smaller, the viewing angle of the LCD device 200 is narrower.

Moreover, the control electrode 316 can be generally comb-shaped which includes a straight connecting part and a plurality of straight branch parts extended from the straight connecting part. The branch parts of the comb-shaped control electrode 316 also can be zigzag shape. Windows of the comb-shaped control electrode 316 are defined by the adjacent straight branch parts and the total area of the windows is 5%˜95% of a total area of pixel electrodes 3231. In addition, the LCD device 200 also can be a TN mode, a super twisted nematic (STN) mode and a PVA mode device. The TN mode LCD device or the STN mode LCD device having the control electrode 316 is able to regulate its viewing angle in order to protect displaying information from being leaking out to others.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

1. A liquid crystal display (LCD) device, comprising:
a liquid crystal panel, comprising:
a first substrate;
a second substrate facing the first substrate;
a liquid crystal layer sandwiched between the first substrate and the second substrate, the liquid crystal layer comprising a plurality of liquid crystal molecules;
a plurality of pixel units arranged in a matrix, each pixel unit comprising a pixel electrode that is applied with a gray voltage;
a common electrode provided between the first substrate and the liquid crystal layer; and
a control electrode defining a plurality of windows, the control electrode being provided between the common electrode and the liquid crystal layer and being electrically insulated from the common electrode; and
wherein a control voltage signal is able to be provided to the control electrode selectively, and if the control voltage signal is provided to the control electrode, a twist direction of liquid crystal molecules corresponding to the control electrode is different from the twist direction of the liquid crystal molecules corresponding to the windows.

2: The LCD device as claimed in claim 1, wherein the control electrode is a transparent conductive layer.

3: The LCD device as claimed in claim 2, wherein the transparent conductive layer is made of a material selected from the group consisting of indium-zinc-oxide and indium-tin-oxide.

4: The LCD device as claimed in claim 1, wherein the windows are arranged in a matrix.

5: The LCD device as claimed in claim 4, wherein each pixel unit corresponds to at least one window.

6: The LCD device as claimed in claim 1, wherein the control electrode is comb-shaped comprising a straight connecting part and a plurality of branch parts extending from the straight connecting part, the windows being defined by the adjacent branch parts.

7: The LCD device as claimed in claim 6, wherein each branch part has a zigzag shape.

8: The LCD device as claimed in claim 4, wherein a total area of the windows is 5%˜95% of the total area of the pixel electrodes.

9: The LCD device as claimed in claim 1, wherein a voltage difference between the control voltage signal and the gray voltage is not less than a saturation voltage value of the liquid crystal molecules of the liquid crystal layer.

10: The LCD device as claimed in claim 1, further comprising an insulating layer covering the common electrode.

11: The LCD device as claimed in claim 1, further comprising a first polarizer provided at an outer surface of the first substrate and a second polarizer provided at an outer surface of the second substrate, the outer surfaces being apart from the liquid crystal layer, wherein the second polarizer has a polarizing axis vertical to the polarizing axis of the first polarizer.

12: The LCD device as claimed in claim 1, wherein the liquid crystal panel is selected from the group consisting of a twisted nematic mode panel, a super twisted nematic mode panel, a multi-domain vertical alignment mode panels and a patterned vertical alignment mode panel.

13: The LCD device as claimed in claim 1, wherein if the control voltage signal is provided to the control electrode, the liquid crystal molecules corresponding to the control electrode twist to align in a direction that is perpendicular to the first substrate.

14: A liquid crystal display (LCD) device, comprising:
a first substrate;
a second substrate facing the first substrate;
a liquid crystal layer sandwiched between the first substrate and the second substrate, the liquid crystal layer comprising a plurality of liquid crystal molecules;
a plurality of pixel electrodes that are arranged on the second substrate and are configured for receiving a gray voltage;
a common electrode provided between the first substrate and the liquid crystal layer, and being configured for receiving a common voltage signal; and
a control electrode defining a plurality of windows, the control electrode being provided between the common electrode and the liquid crystal layer and being electrically insulated from the common electrode;
wherein if no voltage signal is provided to the control electrode, the LCD device is in a wide viewing angle mode; and if a voltage signal is provided to the control electrode, the liquid crystal molecules corresponding to the control electrode twist to align in a direction that is perpendicular to the second substrate thereby reducing the viewing angle of the LCD device.

15: The LCD device as claimed in claim 14, wherein the control electrode is a transparent conductive layer.

16: The LCD device as claimed in claim 14, wherein the windows are arranged in a matrix.

17: The LCD device as claimed in claim 14, wherein a total area of the windows is 5%˜95% of the total area of the pixel electrodes.

18: The LCD device as claimed in claim 14, wherein the control electrode is comb-shaped comprising a straight connecting part and a plurality of branch parts extending from the straight connecting part, and the windows are defined by the adjacent branch parts.

19: The LCD device as claimed in claim 14, wherein a voltage difference between the control voltage signal and the gray voltage is not less than a saturation voltage value of the liquid crystal molecules.

20: The LCD device as claimed in claim 14, further comprising a first polarizer provided at an outer surface of the first substrate and a second polarizer provided at an outer surface of the second substrate, the outer surfaces being apart from the liquid crystal layer, wherein the second polarizer has a polarizing axis vertical to the polarizing axis of the first polarizer.
